(19) United States
(12) Patent Application Publication
(10) Pub. No.: US 2026/0081935 A1
(43) Pub. Date: Mar. 19, 2026

(54) REAL-TIME INTRUSION DETECTION IN A DIGITAL SUBSTATION

(71) Applicant: GRIDSENTRY PRIVATE LIMITED, Bengaluru (IN)

(72) Inventors: Devika Jay, Calicut Kerala (IN); Rajesh Rathi, Bengaluru (IN); Tanushree Bhattacharjee, Bengaluru (IN); Umayal, Coimbatore (IN)

(21) Appl. No.: 19/331,551

(22) Filed: Sep. 17, 2025

(30) Foreign Application Priority Data
Sep. 17, 2024 (IN) 202441070225

(51) Int. Cl. H04L 9/40; H04L 41/16

(52) U.S. Cl. CPC H04L 63/1416; H04L 41/16

(57) ABSTRACT

The present disclosure relates to systems and methods for detecting the real-time intrusion in the digital substation. The present disclosure may include a system for real-time intrusion detection that comprising: a processor, wherein the processor is configured to: receive one or more message packets from at least one network switch associated with at least one electrical node of the digital substation. Further, the processor is configured to implement an integrative intrusion analysis on the one or more message packets. Further, the intrusion may be determined in real-time based on the integrative intrusion analysis of the one or more message packets. The system may detect the real-time intrusion while managing the time-sensitive flow of the message packets in the digital substation, in accordance with the present disclosure.

### TECHNICAL FIELD

The present disclosure generally relates to intrusion detection in digital substation. More particularly, but not exclusively, the present disclosure relates to systems and methods for detecting the intrusion in the digital substation in real time.

### BACKGROUND

The information disclosed in this background section is only for enhancement of understanding of the general background of the disclosure and should not be taken as an acknowledgement or any form of suggestion that this information forms the prior art already known to a person skilled in the art.

Substation automation systems utilizing standard communication protocols (that includes International Electrotechnical Commission (IEC) security standards. e.g., IEC-61850, DNP3.0, Modbus) currently lack specified security features to address cyberattacks within substation communication network. To address this security gap, a series of security standards, such as the IEC-62351 standard, have been developed. Nevertheless, these standards do not recommend encryption techniques (e.g., Generic Object Oriented Substation Event (GOOSE)) that consider the time-critical nature of message packets. Consequently, unencrypted communication channels remain between substation automation systems, rendering them vulnerable to cyber threats and/or attacks. This vulnerability exposes the communication channels and the associated message packets to cyber threats and/or attacks, such as potential Man-in-the-Middle (MITM) attacks, including data manipulation, flooding, replay, masquerading, etc.

Hence, there is a need for a technique that addresses the time criticality and security challenges associated with protecting the electrical substations from the cyberattacks. The present disclosure aims to address one or more of these limitations or other deficiencies present in the prior art.

### SUMMARY

This summary is provided to introduce a selection of concepts, in a simplified format, which are further described in detailed description of the present disclosure. This summary is neither intended to identify key or essential inventive concepts of the disclosure nor is it intended to determine the scope of the disclosure.

The present disclosure relates to real-time intrusion detection in digital substation. More particularly, but not exclusively, the present disclosure relates to systems and methods for detecting the real-time intrusion in the digital substation. The system for real-time intrusion detection comprises a processor which is configured to receive one or more message packets from at least one network switch associated with at least one electrical node of the digital substation. Further, the processor is configured to implement an integrative intrusion analysis on the one or more message packets. Further, the intrusion may be determined in real-time based on the integrative intrusion analysis of the one or more message packets. The system may detect the real-time intrusion while managing the time-sensitive flow of the message packets in the digital substation, in accordance with the present disclosure.

The present disclosure may include a method for real-time intrusion detection in the digital substation. The method comprises receiving one or more message packets from at least one network switch associated with at least one electrical node of the digital substation. The method further comprises implementing an integrative intrusion analysis on the one or more message packets. Further, the method comprises determining the intrusion in real-time based on the integrative intrusion analysis of the one or more message packets. The method may detect the real-time intrusion while managing the time-sensitive flow of the message packets in the digital substation, in accordance with the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of device and/or methods in accordance with embodiments of the present subject matter are now described below, by way of example only, and with reference to the accompanying drawings.

FIG. 1 illustrates an exemplary environment of a digital substation comprising an intelligent intrusion detection system (IIDS) device, in accordance with an embodiment of the present disclosure.

FIG. 2 illustrates of a system architecture of the digital substation of FIG. 1, in accordance with an embodiment of the present disclosure.

FIG. 3 illustrates an intelligent intrusion detection (IIDS) system of the digital substation of FIG. 1 and FIG. 2, in accordance with an embodiment of the present disclosure.

FIG. 4A illustrates a flowchart of a method of real-time intrusion detection performed by the IIDS system, in accordance with an embodiment of the present disclosure.

FIG. 4B illustrates a flowchart representation of a method of real-time intrusion detection performed by the IIDS system, in accordance with an embodiment of the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration. ” Any embodiment or implementation of the present subject matter described herein as “exemplary” is not necessarily to be construed as preferred or advantageous over other embodiments.

As used herein, the term “comprising” is not intended to be limiting, but may be a transitional term synonymous with “including,” “containing,” or “characterized by. ” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

Typically, digital electrical substations (also referred hereinafter as digital substations) in power networks incorporate primary devices that are arranged in a switching station. The primary devices may include electrical cables, switches, circuit breakers, power transformers, instrument transformers, or etc., but not limited thereto. The primary devices may be operated by the use of an automated digital substation, which in turn may control, protect, and monitor the electrical substations. The digital subsystem may include a plurality of programmable devices, such as distributed intelligent electronic devices (IEDs), that are interconnected through the communication network. With an increasing degree of automation and increasing usage of IEDs, there may also be an increasing need to reliably detect critical situations which may affect optimal performance of the digital substation. The critical events may include, for example, security intrusions, timing issues during flow of message packets, any incorrect state of the electrical and/or digital substation, but not limited thereto.

The following disclosure may provide exemplary systems, devices, and methods for detecting real-time intrusion while managing time-sensitive flow of the message packets in the digital substation. In an embodiment, the present disclosure may include systems and methods for real-time anomaly detection, as explained in the examples provided below. However, the present disclosure is not limited thereto, and the systems, methods, and devices may be utilized for any suitable purpose but not limited to intrusion detection in the digital substation.

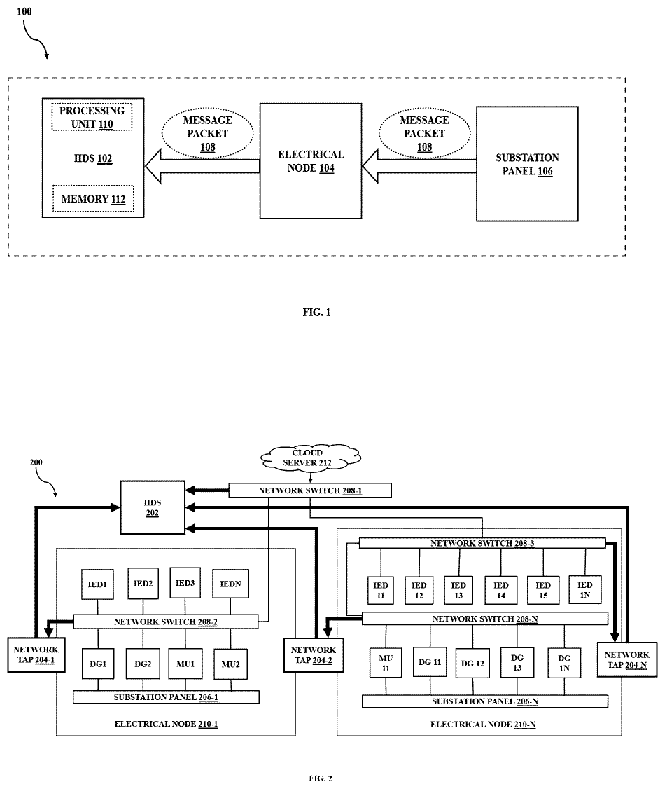

FIG. 1 illustrates of an exemplary environment 100 of a digital substation comprising an intelligent intrusion detection system (IIDS) device 102, in accordance with an embodiment of the present disclosure. In an embodiment, the exemplary environment 100 of the digital substation may include at least one of the IIDS device 102, a plurality of electrical nodes 104, a plurality of substation panels 106, etc., but not limited thereto. The exemplary environment 100 may include a plurality of electrical nodes 104 and the plurality of substation panels 106. However, FIG. 1 only illustrate one electrical node 104 and one substation panel 106 for the sake of brevity. In an embodiment, the exemplary environment 100 of the digital substation may be implemented using various other modules/units, entities, and provided as a component of a larger system, such as a substation, distribution feeder circuits, protective equipments, primary devices, distribution transformers, circuit switches, and/or in various other forms. Thus, the exemplary environment 100 of the digital substation may be used for detecting the real-time intrusion while managing time-sensitive flow of the message packets 108, in accordance with the present disclosure.

In an embodiment, the IIDS device 102 may include at least one of a processing unit 110 and a memory 112. In some embodiments, the IIDS device 102 maybe the IEDs that may communicate with various components of the digital substation. The processing unit 110 may include at least one or more processors, a suitable logic, circuitry, and/or interfaces that are operable to execute instructions stored in the memory 112 to perform various functions, as per the present subject matter. The processing unit 110 may execute an algorithm stored in the memory 112 to perform the real-time intrusion detection. The processing unit 110 may also be configured to decode and execute any instructions received from at least one or more other electronic devices or server(s). The at least one or more processors may include one or more general-purpose processors and/or one or more special-purpose processors (e.g., digital signal processors On Chip (SOC) Field Programmable Gate Array (FPGA) processor, etc.). Further, the at least one or more processors may be configured to execute one or more computer-readable program instructions, such as program instructions to carry out any of the functions described in the description.

In one example embodiment, the IIDS device 102 including the memory 112 that may store a set of instructions and data related to message processing in the digital substation. Further, the memory 112 includes one or more instructions that are executable by the at least one or more processors to perform specific operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, cloud computing platforms, or other type of media/machine-readable medium suitable for storing electronic instructions.

In an embodiment, the exemplary environment 100 including the plurality of electrical nodes 104 may support the transmission or reception of the message packets 108, for enabling timely flow of the message packets 108 within the digital substation. In an embodiment of the present disclosure, the exemplary environment 100 including the plurality of substation panels 106 for managing flow of data of the message packets 108.

In an embodiment of the present disclosure, the exemplary environment 100 including the IIDS device 102 may communicate with the plurality of substation panels 106 via the plurality of electrical nodes 104. It may be apparent to one skilled in the art that the above-mentioned components of the IIDS device 102, the plurality of electrical nodes 104, the plurality of substation panels 106 may be provided for illustration purposes. In an embodiment, the exemplary environment 100 may comprise a basic configuration made up of interchangeable components, in accordance with the present disclosure, without departing from the scope of the present disclosure. The exemplary environment 100 of the digital substation including the one or more above-mentioned components, may be configured to detect the real-time intrusion while managing time-sensitive flow of the message packets 108, in accordance with the present disclosure.

FIG. 2 illustrates of a system architecture 200 of the digital substation of FIG. 1, in accordance with an embodiment of the present disclosure. In an embodiment, the system architecture 200 may include one or more components such as an IIDS device 202, one or more network Test Access Point (TAPs) 204-1, 2014-2, . . . 204-N (also collectively referred to hereinafter as network TAP 204), substation panels 206-1, 206-2, . . . 206-N (also collectively referred to hereinafter as substation panels 206), network switches 208-1, 208-2, . . . 208-N (also collectively referred to hereinafter as network switch 208). In an embodiment of the system architecture 200, the IIDS device 202 may form a control centre of the system architecture 200. The IIDS device 202, the substation panels 206, are similar, in terms of structure and functionalities, to the IIDS device 102, the substation panel 106, respectively, of FIG. 1.

In an embodiment, the IIDS device 202 including the network TAP 204 may act as a junction or tap for enabling transceiving of the message packets 108 in the digital substation. In particular, the network TAP 204 may transmit or receive the message packets 108 that originates from at least one of the plurality of electrical nodes 210 to the IIDS device 202.

In an embodiment, the IIDS device 202 including plurality of electrical nodes 210 that include the network switch 208, for transmitting or receiving the message packets 108 that originates from at least one of the plurality of substation panels 206. The network switch 208 may direct the data that it receives from one port to another port of the plurality of substation panels 206. The network switch 208 may direct the data based on information in the message packet's header. For example, the information may correspond to Media Access Control (MAC) address of sender and MAC address of receiver. The MAC address may be a unique identifier (ID) assigned to each device (the sender or the receiver) connected to the communication network. The primary devices may use the MAC address of transmitting devices to ensure that the message packets 108 reach the particular receiving device. Thus, the plurality of substation panels 206 may direct the data to the devices based on MAC ID that significantly improves the efficiency of the flow of data of the message packets 108.

The system architecture 200 may include one or more IEDs such as IED 1, . . . N coupled to the substation panels 206 of the digital substation. The one or more IEDs may perform operations of controlling, protecting, and monitoring operation of the primary devices of the respective electrical substations (e.g., REB-670, REC-670, RED-670, REG-670, etc., but not limiting thereto). The one or more IEDs may transmit output of the primary devices in analog signal format to one or more digitizers of the digital substation. Communication between the one or more IEDs may be performed the according to communication protocols, such as IEC-61850, DNP3.0, Modbus, or etc. but not limited thereto.

The system architecture 200 may include one or more digitizer (DG), such as DG1, . . . N coupled to the substation panels 206 of the digital substation. The one or more digitizers may digitize the analog signal output from the primary devices and then transmits sampled valued (SV) data streams to the control centre via an ethernet network. The ethernet network may include network switch 208 that allows the network TAP 204 to exchange data between the communication interfaces.

The system architecture 200 may include one or more merging unit (MU), such as MU1, . . . N coupled to the substation panels 206 of the digital substation. The one or more merging unit may publish the SV data streams to the control centre via the ethernet network. The one or more merging unit may transmit the SV data streams by substation relays for providing phase overcurrent and breaker-failure backup protection in the digital substation.

In another embodiment, the system architecture 200 of the digital substation may include a basic configuration made up of one or more interchangeable components, in accordance with the present disclosure. In an embodiment, the system architecture 200 may perform basic functioning of detecting the real-time intrusion while managing time-sensitive flow of the message packets 108 in the digital substation, in accordance with the present disclosure.

In an example embodiment, the system architecture 200 of the digital substation may include a cloud server 212 that correspond to one or more servers. The cloud server 212 may be accessed over the internet, the software and databases that run on the one or more servers. The cloud server 212 may be located in data centres all over the world. In an example, the digital substation may receive a plurality of the message packets 108 from an external network and/or an external device via the cloud server 212.

In an exemplary embodiment, the IIDS device 202 comprising the processing unit 110 may be configured to receive one or more message packets from the network switch 208. The network switch 208 may be associated with the at least one electrical node of the digital substation. The network switch 208 may be mounted at the electrical node 210 to tap the one or more message packets within the system architecture 200. The tapped one or more message packets may be then fed into the IIDS device 202. Thus, the IIDS device 202 may receive the one or more message packets for detecting the real-time intrusion while managing time-sensitive flow of the one or more message packets, in accordance with the present disclosure.

In an embodiment, the IIDS device 202 comprising the processing unit 110 may be configured to implement an integrative intrusion analysis on the one or more message packets. The processing unit 110 may be configured to determine the intrusion in real-time based on the integrative intrusion analysis for detecting the real-time intrusion in the digital substation while managing the time-sensitive flow of the message packets 108, in accordance with the present disclosure.

In an embodiment of the present disclosure, the IIDS device 202 may analyse the one or more message packets based on the integrative intrusion analysis. The IIDS device 202 may include at least one of a rule-based engine, an ensemble unsupervised learning engine, model-based electrical network analysis engine for analysing the one or more message packets based on the integrative intrusion analysis.

In an embodiment of the present disclosure, the IIDS device 202 may include the rule-based engine for applying at least one pre-defined rule to the one or more message packets that corresponds to the integrative intrusion analysis. The rule-based engine may include applying the at least one pre-defined rule to the one or more message packet for identifying a first anomaly in the one or more message packets. The at least one pre-defined rule may include a set of signatures of pre-identified anomalous patterns. Further, the at least one pre-defined rule may include testing all domain specific and protocol specific pre-defined rules.

In an embodiment, the IIDS device 202 comprising the processing unit 110 may be configured to generate an alarm, based on the identified first anomaly in the one or more message packets. Thus, the IIDS device 202, by applying the at least one pre-defined rule to the one or more message packets, may detect the real-time intrusion while managing time-sensitive flow of the one or more message packets, in accordance with the present disclosure.

In an embodiment of the present disclosure, the IIDS device 202 may include the ensemble unsupervised learning engine for implementing a machine learning (ML) model to the one or more message packets. The ensemble unsupervised learning engine may implement the ML model for identifying the one or more anomalies in the one or more message packets based on the integrative intrusion analysis. The ML model may be a data-driven technology for intrusion detection that leverages a combination of unsupervised learning and statistical techniques. The ML model may incorporate at least one of cybersecurity method that involves analyzing and interpreting large volumes of data from various sources for detecting abnormal patterns or behaviours in the communication network traffic. The Unsupervised Learning algorithms may be one of: Density-Based Spatial Clustering of Applications (DBSCAN), One-Class Support Vector Machine (OSVM), Unsupervised K-Nearest Neighbors (UKNN), Local Outlier Factor (LOF), Local Outlier Factor Detector (LOFD), k-Nearest Neighbors Detector (KNND), etc., but not limited thereto. The Statistical Learning algorithms may be at least one of: Interquartile Range (IQR), Median Absolute Deviation (MAD), Modified Z-Score (MZS), etc., but not limited thereto. As per some embodiments, instead of relying on pre-labelled or annotated data, data-driven IIDS may use the unsupervised learning algorithms to identify potential intrusions based solely on inherent characteristics of the data stream. As per some embodiments, by combining the unsupervised learning and statistical techniques, the data-driven IIDS may become more adaptive and capable of detecting novel and previously unseen attacks for identifying the potential intrusions in the one or more message packets.

The data-driven IIDS may include implementing ensemble learning techniques with consideration of different numbers of the unsupervised learning algorithms for enhancing accuracy and robustness of the data-driven technique. Thus, the ensemble learning techniques may provide a solution of combining outputs of multiple anomaly detection models that encompass both the statistical and unsupervised techniques. The integration of multiple anomaly detection models may allow the ensemble learning techniques to leverage the benefits of statistical analysis and unsupervised learning for detecting novel and previously unseen anomalies. By combining the strengths of both approaches, the ensemble learning techniques may reduce risk of false positives and false negatives, providing a more balanced and reliable detection outcome. The ensemble learning techniques may be at least one of: Stacking, Weighted average ensemble, Majority voting, etc., but not limited thereto.

The IIDS device 202 implementing the ML model may identify one or more anomalies in the one or more message packets. The one or more anomalies may include at least one of the first anomaly and a second anomaly in the one or more message packets. The IIDS device 202 may include implementing the ML model upon applying the at least one pre-defined rule to the one or more message packets. Thus, the IIDS device 202 implementing the ML model may identify the at least one of the first anomaly and the second anomaly in the one or more message packets, in accordance with the present disclosure.

In an embodiment, the processing unit 110 may be configured to implement the ML model for creating an environment for detecting the real time intrusion in the message packets. The ML model may create the environment for identifying the second anomaly in the one or more message packets. The environment may include at least one learning agent that associated with the environment. The learning agent of the environment may be configured to analyse each data field of the one or more message packets. Thus, the learning agent of the ML model, on analysing each data field of the one or more message packets, may identify the second anomaly in the one or more message packets, in accordance with the present disclosure.

Further, the environment including the learning agent may identify the at least one of the first anomaly and the second anomaly based on the analysis of each data field of the one or more message packets. Thus, the learning agent of the ML model may identify the at least one of the first anomaly and the second anomaly based on the result of the analysis, in accordance with the present disclosure.

In an exemplary embodiment, the IIDS device 202 comprising the processing unit 110 may be configured to generate an alarm, based on the identified second anomaly in the one or more message packets.

In an embodiment, the IIDS device 202 comprising the processing unit 110 may be configured to implement a training agent in the environment of the ML model. Thus, the IIDS device 202 may include at least one training agent that associated with the environment. The training agent may be configured to train the learning agent based on normal and disturbance packets collected from the communication network. Further, the training agent may be configured to populate a plurality of pre-defined anomalous patterns and zero-day anomalous patterns based on the normal and disturbance packets collected from the communication network. The plurality of zero-day anomalous patterns may include one or more unidentified anomalous patterns. For example, the one or more unidentified anomalous patterns may correspond to the patterns that does not conform to the expected data pattern. Thus, the IIDS device 202 implementing the at least one ML model may detect the real-time intrusion based on populating the plurality of pre-defined anomalous patterns and zero-day anomalous patterns within the one or more message packets 108, in accordance with the present disclosure.

In an embodiment of the present disclosure, the IIDS device 202 comprising the model-based electrical network analysis engine may implement a topology analysis that corresponds to the integrative intrusion analysis. The topology analysis may comprise assessing at least one of current topology or voltage topology pertaining to the at least one electrical node of the digital substation. The topology analysis may be performed upon implementing the ML model of the integrative intrusion analysis of the one or more message packets.

The model-based electrical network analysis engine may include at least one of electrical network implications and correlation between one or more message packets (e.g., GOOSE packets, etc.). The electrical network implications and correlation between one or more message packets, may be attained from the one or more IEDs to achieve a high accuracy IIDS. The topology analysis may be implemented for considering Single Line Diagram (SLD) of the electrical substation that depends on IIDS payload measurements (e.g., GOOSE payload, etc.). The topology analysis may include receiving measured values from the physical devices to form nodal equations that corresponds to the current topology or voltage topology (e.g., Kirchoff's Current Law (KCL), Kirchoff's Voltage Law (KVL), etc.). Further, the current topology or voltage topology may be followed by an approximate Linear relationship (e.g., Singular Value Decomposition (SVD), etc.) for further development of the communication network.

In an embodiment, the IIDS may include the topology analysis that assess the at least one of current topology or voltage topology for identifying two or more anomalies in the one or more message packets. The two or more anomalies may include identifying at least one of the first anomaly, the second anomaly, and a third anomaly in the one or more message packets. In an embodiment, the IIDS device 202 comprising the processing unit 110 may be configured to generate an alarm, based on the identified third anomaly in the one or more message packets. Thus, implementing the at least one topology analysis to the one or more message packets may detect the real-time intrusion while managing time-sensitive flow of the one or more message packets, in accordance with the present disclosure.

Further, the IIDS may include generating the alarms based on the identified one or more anomalies in the one or more message packets, to initiate an incidence response plan, in accordance with the present disclosure. In an embodiment, the IIDS device 202 comprising the processing unit 110 may be configured to initiate an incidence response plan upon determining the intrusion in the one or more message packets. The incidence response plan may include applying one or more pre-defined conditions for controlling associated operation of the at least one electrical node of the digital substation. The IIDS may detect measurement values and send, based on the measurement values, a trip signal for controlling the at least one of electrically-operable switches or electronically-operable switches of the at least one electrical node. The IIDS may detect the measurement values and send the signal to the primary devices, such that the whole process may be accomplished within a predetermined time duration (e.g., 4 milliseconds). More particularly, the IIDS may detect measurement values within the time that next message packet arrives at the primary devices that ensure high speed response especially in the critical infrastructure. Thus, the pre-defined conditions may include controlling at least one of electrically-operable switches or electronically-operable switches of the at least one electrical node. Furthermore, the incidence response plan may identify the two or more anomalies in the one or more message packets in the real-time, based on applying the one or more pre-defined conditions. Thus, the IIDS device 202 may initiate the incidence response plan based on satisfying the pre-defined conditions for identifying the at least one or more anomalies in the one or more message packets.

FIG. 3 illustrates an intelligent intrusion detection (IIDS) system 300 of the digital substation of FIG. 1 and FIG. 2, in accordance with an embodiment of the present disclosure. The IIDS system 300 may correspond to the IIDS device 202 of FIG. 2. In an embodiment, the IIDS system 300 of the digital substation may include at least one of a IIDS device 302 correspond to the IIDS device 202 of FIG. 2, network TAP 304 correspond to the network TAP 204 of FIG. 2, a protocol segregator 306, an agent cluster 308, alarm and historian 310. The IIDS system 300 may include at least one or more interchangeable modules to perform the basic functioning of the real-time intrusion detection while managing time-sensitive flow of the message packets, in accordance with the present disclosure.

In an embodiment, the IIDS system 300 including the protocol segregator 306 may classify the one or more message packets received from the at least one electrical node. The protocol segregator may classify the one or more message packets based on extracting at least one of features such as communication network protocol type, type of message, the sender MAC ID, the receiver MAC ID. The communication network protocol type may be at least one of standard communication protocols PROTOCOL-1, 2, . . . N (e.g., IEC 61850, DNP3, Modbus, and etc.), but not limited thereto. The standard communication protocols may recommend encryption techniques that consider the time-sensitive flow of message packets (e.g., GOOSE). The recommended encryption techniques may involve a controlled model mechanism under which format of data (Sample Value (SV) of the data) is grouped into a data set and transmitted within the predetermined time duration.

In an embodiment, the IIDS system 300 may receive measurement values of the primary devices for detecting whether the measurement values belong to a normal (e.g., acceptable range) or abnormal state. The abnormal state may include at least one of a high current situation, a fault situation, and, etc., but not limited thereto. The IIDS may detect the state of the measurement values and send a trip signal back to the primary devices for controlling the state of the digital substation. The IIDS system 300 may detect the state and send the trip signal to the primary devices, such that the whole process may be accomplished within the predetermined time duration. More particularly, the IIDS may detect measurement values within the predetermined time duration before which the next message packet arrives at the primary devices. Thus, the IIDS system 300 may detect the measurement values within the predetermined time duration to ensure high speed response especially in the critical infrastructure, in accordance with the present disclosure.

The at least one of the features—the type of message may offer a brief description that helps the receiving device to identify nature of the message and determine appropriate response from the receiving device. For example, a few common message types are Type 0—Echo reply, Type 3—Destination unreachable, Type 5—Redirect Message, Type 11—Time Exceeded, etc., but not limited thereto. Thus, the IIDS system 300 may classify the one or more message packets based on extracting the at least one of features that manages the time-sensitive flow of the message packets, in accordance with the present disclosure.

In an embodiment of the IIDS system 300, the processing unit 110 may be configured to classify the one or more message packets based on respective communication network protocol types. The communication network protocol types may be based on the at least one of the standard communication protocols.

In an embodiment, the agent cluster 308 may include a plurality of anomaly identifying agents for implementing the integrative intrusion analysis on the one or more message packets. The plurality of anomaly identifying agents may include one or more anomaly identifying agents such as agent 1, 2, . . . N. The plurality of anomaly identifying agents may assess each of the one or more message packets based on each of the sender MAC ID or receiver MAC ID. The IIDS device 202 may implement the integrative intrusion analysis on the one or more message packets upon identifying and classifying the one or more message packets.

Further, the plurality of anomaly identifying agents may determine the intrusion in the one or more message packets. The IIDS system 300 may determine the intrusion in the one or more message packets based on a result of the assessment.

In an embodiment, the IIDS system 300 comprising the alarm and historian 310 for recording at least one event of determining the one or more anomalies in the one or more message packets. The alarm and historian 310 may record the at least one single event that include generating the alarm based on the determined one or more anomalies in the one or more message packets.

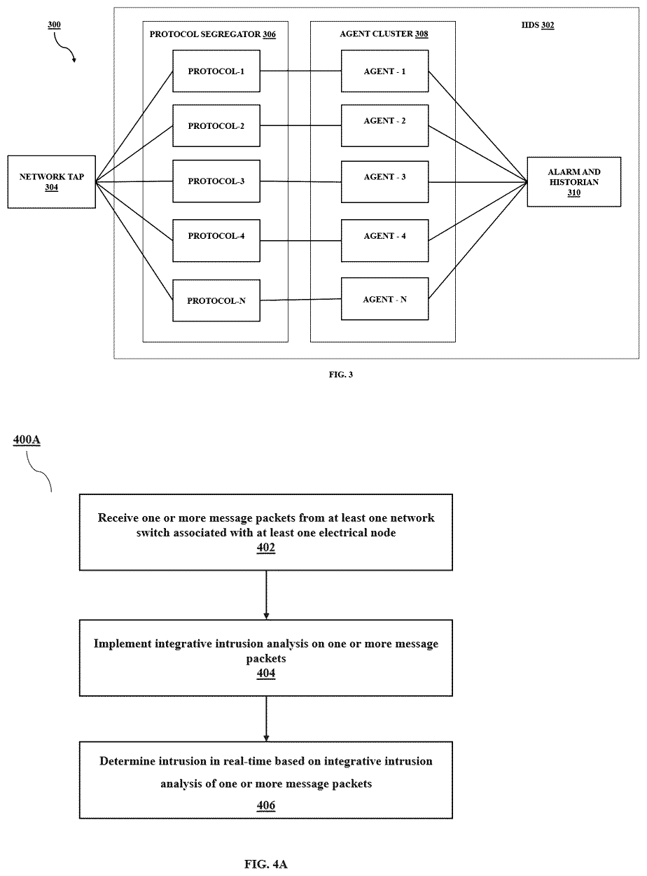

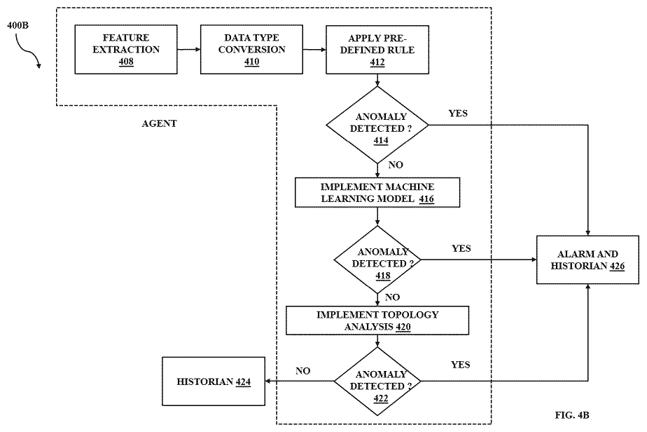

FIG. 4A illustrates a method 400A performed by the IIDS system 300, in accordance with an embodiment of the present disclosure. As illustrated in FIG. 4A, the method 400A may comprise one or more steps. The method 400A may be described in the general context of computer executable instructions. Generally, computer executable instructions can include routines, programs, objects, components, data structures, procedures, modules, and functions, which perform particular functions or implement particular abstract data types.

The order in which the method 400A is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

In an embodiment, the method 400A may comprise (at step 402) receiving one or more message packets from at least one network switch associated with the at least one electrical node of the digital substation. In an embodiment, the method 400A may comprise (at step 404) implementing the integrative intrusion analysis on the one or more message packets. In an embodiment, the method 400A may comprise (at step 406) determining the intrusion in real-time based on the integrative intrusion analysis of the one or more message packets. The method 400A of the IIDS system 300 may detect the real-time intrusion while managing the time-sensitive flow of the message packets 108 in the digital substation, in accordance with the present disclosure.

FIG. 4B illustrates a flowchart representation of a method 400B performed by the IIDS system 300, in accordance with an embodiment of the present disclosure.

As illustrated in FIG. 4B, the method 400B may comprise one or more steps. The method 400B may be described in the general context of computer executable instructions. Generally, computer executable instructions can include routines, programs, objects, components, data structures, procedures, modules, and functions, which perform particular functions or implement particular abstract data types.

The order in which the method 400B is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

The method 400B of the IIDS system 300, may comprise classifying the one or more message packets by a protocol segregator, upon receiving the one or more message packets from at least one network switch. In an embodiment, the method 400B may include classifying (at step 408) the one or more message packets based on extracting the at least one of features such as communication network protocol type, type of message, the sender MAC ID, the receiver MAC ID, and etc., but not limited thereto. Further, classifying the one or more message packets may be upon receiving the one or more message packets.

In an embodiment, the method 400B may include converting (at step 410) the analog signal output of the primary devices into the SV data streams of the one or more message packets. In an embodiment, the method 400B may comprise applying (at step 412) the at least one pre-defined rule by a rule-based engine, on the one or more message packets. In an embodiment, the method 400B may comprise identifying (at step 414) the first anomaly in the one or more message packets. The at least one pre-defined rule may include a set of signatures of pre-identified anomalous patterns.

In an embodiment, the method 400B may include generating (at step 426) an alarm based on the identified first anomaly in the one or more message packets.

In an embodiment, the method 400B may include implementing (at step 416) the ML model, by the ensemble unsupervised learning engine. In an embodiment, the method 400B may comprise identifying (at step 418) the at least one of the first anomaly and the second anomaly in the one or more message packets. The ML model may be implemented after applying the at least one pre-defined rule.

In an embodiment, the method 400B may comprise implementing the ML model to create an environment for identifying the second anomaly in the one or more message packets. Further, the method 400B may include a learning agent that interacts with the environment created by the ML model. The learning agent may be configured to analyse each data field of the one or more message packets. The learning agent may be configured to identify the at least one of the first anomaly and the second anomaly based on result of the analysis.

In an embodiment, the method 400B may comprise implementing a training agent in the environment of the ML model. The training agent may be configured to train the learning agent based on normal and disturbance packets collected from a network. Further, the training agent may be configured to populate a plurality of pre-defined anomalous patterns and zero-day anomalous patterns. The zero-day anomalous patterns may include unidentified anomalous patterns. In an embodiment, the method 400B may include generating (at step 426) an alarm based on the identified second anomaly in the one or more message packets.

In an embodiment, the method 400B may include implementing (at step 420) a topology analysis, by the model-based electrical network analysis engine. In an embodiment, the method 400B may comprise identifying (at step 422) the at least one of the first anomaly, the second anomaly, and a third anomaly in the one or more message packets. The topology analysis may comprise assessing at least one of current topology or voltage topology pertaining to the at least one electrical node. Further, the topology analysis may be implemented after implementing the ML model to the one or more message packets. In an embodiment, the method 400B may include generating (at step 426) an alarm based on the identified third anomaly in the one or more message packets.

In an embodiment, the method 400B may include recording (at step 424) at least one single event by a historian device included in the alarm and historian 310. The historian device may record the at least one single event that include generating the alarm based on identifying the one or more anomalies in the one or more message packets.

In an embodiment, the method 400B may include generating an incidence response plan upon determining the intrusion in the one or more message packets in the real-time. The incidence response plan may include the pre-defined conditions for controlling the associated operation of the at least one electrical node Further, the incidence response plan may be initiated by the electrically operable switches or electronically operable switches of the at least one electrical node based on initiating the incidence response plan in the real-time.

In an embodiment, the method 400B may include classifying the one or more message packets based on the respective network protocol types. In an embodiment, the method 400B may include implementing the integrative intrusion analysis of the one or more message packets, by the plurality of anomaly identifying agents. Further, the integrative intrusion analysis on the one or more message packets may be implemented upon classifying the one or more message packets.

In an embodiment, the method 400B may include assessing each of the one or more message packets by the one or more anomaly identifying agents from the plurality of anomaly identifying agents. In an embodiment, the method 400B may include determining the intrusion in the one or more message packets. based on a result of the assessment.

The present disclosure may include identifying the one or more anomalies in the message packets based on:
Predefined rule defined by the rule-based engine (e.g., relay engineer).
data driven techniques (such as ensemble learning techniques) include unsupervised learning techniques, statistical techniques, and etc.
model-based electrical network analysis engine of the substation electrical network or the Single Line Diagram of the substation.

Thus, identifying the one or more anomalies in the message packets may ensure smooth, safe protection, and control of the digital substation.

Further, the present disclosure aims to achieve
zero false positive and false negative alarms with the proposed pipeline of the IIDS system
anomaly detection of Modbus and DNP3 devices.
real-time intrusion detection rate that considers the time critical nature of message packets (e.g., GOOSE and SV packets in IEC 61850 protocol with detection rate less than 4 ms).

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. Accordingly, the disclosure of the embodiments of the disclosure is intended to be illustrative, but not limiting, of the scope of the disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

We claim:

1. A system for real-time intrusion detection in a digital substation, the system comprising:
a processor, wherein the processor is configured to:
receive one or more message packets from at least one network switch associated with at least one electrical node of the digital substation; and
implement an integrative intrusion analysis on the one or more message packets, wherein the integrative intrusion analysis comprises:
applying at least one pre-defined rule, by a rule-based engine, to identify a first anomaly in the one or more message packets, wherein the at least one pre-defined rule includes a set of signatures of pre-identified anomalous patterns;
implementing, upon applying the at least one pre-defined rule, a machine learning (ML) model, by an ensemble unsupervised learning engine, to identify at least one of the first anomaly and a second anomaly in the one or more message packets;
implementing, upon implementing the ML model to the one or more message packets, a topology analysis, by a model-based electrical network analysis engine, to identify at least one of the first anomaly, the second anomaly, and a third anomaly in the one or more message packets, wherein the topology analysis comprises assessing at least one of current topology or voltage topology pertaining to the at least one electrical node; and
determining the intrusion in real-time based on the integrative intrusion analysis of the one or more message packets.

2. The system of claim 1, wherein, to identify the second anomaly in the one or more message packets, the processor is further configured to:
implement the ML model to create an environment such that a learning agent, associated with the environment, is configured to:
analyse each data field of the one or more message packets; and
identify at least one of the first anomaly and the second anomaly based on a result of the analysis.

3. The system of claim 1, wherein the processor is configured to:
implement a training agent in the environment of the ML model, wherein the training agent is configured to train the learning agent based on normal and disturbance packets collected from a network, and populate a plurality of pre-defined anomalous patterns and zero-day anomalous patterns, wherein the zero-day anomalous patterns include unidentified anomalous patterns.

4. The system of claim 1, wherein the processor is further configured to:
generate an alarm, based on the identified first anomaly in the one or more message packets.

5. The system of claim 1, wherein the processor is further configured to:
generate an alarm, based on the identified second anomaly in the one or more message packets.

6. The system of claim 1, wherein the processor is further configured to:
generate an alarm, based on the identified third anomaly in the one or more message packets.

7. The system of claim 1, wherein the processor is further configured to:
generate an incidence response plan upon determining the intrusion in the one or more message packets in the real-time, wherein the incidence response plan comprises pre-defined conditions for controlling, by electrically-operable switches or electronically-operable switches, associated operation of the at least one electrical node based on initiating the incidence response plan in the real-time.

8. The system of claim 1, wherein, upon receiving the one or more message packets, the processor is configured to:
classify, by a protocol segregator, the one or more message packets based on respective network protocol types; and
upon classifying the one or more message packets, implement, by a plurality of anomaly identifying agents, the integrative intrusion analysis on the one or more message packets, wherein, to implement the integrative intrusion analysis, the plurality of anomaly identifying agents is to:
assess, by one or more anomaly identifying agents from the plurality of anomaly identifying agents, each of the one or more message packets; and
determine, based on a result of the assessment and by the one or more anomaly identifying agents from the plurality of anomaly identifying agents, the intrusion in the one or more message packets.

9. The system of claim 1, wherein the protocol segregator is based on at least one of IEC 61850, DNP3 and Modbus.

10. A method for real-time intrusion detection in a digital substation, the method comprises:
receiving one or more message packets from at least one network switch associated with at least one electrical node of the digital substation; and
implementing an integrative intrusion analysis on the one or more message packets, wherein the integrative intrusion analysis comprises:
applying at least one pre-defined rule, by a rule-based engine, to identify a first anomaly in the one or more message packets, wherein the at least one pre-defined rule includes a set of signatures of pre-identified anomalous patterns;
implementing, upon applying the at least one pre-defined rule, a machine learning (ML) model, by an ensemble unsupervised learning engine, to identify at least one of the first anomaly and a second anomaly in the one or more message packets;
implementing, upon implementing the ML model to the one or more message packets, a topology analysis, by a model-based electrical network analysis engine, to identify at least one of the first anomaly, the second anomaly, and a third anomaly in the one or more message packets, wherein the topology analysis comprises assessing at least one of current topology or voltage topology pertaining to the at least one electrical node; and
determining the intrusion in real-time based on the integrative intrusion analysis of the one or more message packets.

11. The method of claim 10, wherein, the identifying of the second anomaly in the one or more message packets, further comprises:
implementing the ML model to create an environment such that a learning agent, associated with the environment, is configured for:
analysing each data field of the one or more message packets; and
identifying at least one of the first anomaly and the second anomaly based on result of the analysis.

12. The method of claim 10, comprises: implementing a training agent in the environment of the ML model, wherein the training agent is configured to train the learning agent based on normal and disturbance packets collected from a network, and populate a plurality of pre-defined anomalous patterns and zero-day anomalous patterns, wherein the zero-day anomalous patterns include unidentified anomalous patterns.

13. The method of claim 10, further comprises
generating an alarm, based on the identified first anomaly in the one or more message packets.

14. The method of claim 10, further comprises
generating an alarm, based on the identified second anomaly in the one or more message packets.

15. The method of claim 10, further comprises
generating an alarm, based on the identified third anomaly in the one or more message packets.

16. The method of claim 10, further comprises
generating an incidence response plan upon determining the intrusion in the one or more message packets in the real-time, wherein the incidence response plan comprises pre-defined conditions for controlling, by electrically operable switches or electronically operable switches, associated operation of the at least one electrical node based on initiating the incidence response plan in the real-time.

17. The method of claim 10, upon receiving the one or more message packets, comprises:
classifying, by a protocol segregator, the one or more message packets based on respective network protocol types; and
upon classifying the one or more message packets, implementing, by a plurality of anomaly identifying agents, the integrative intrusion analysis on the one or more message packets, wherein, to implement the integrative intrusion analysis, the plurality of anomaly identifying agents comprises:
assessing, by one or more anomaly identifying agents from the plurality of anomaly identifying agents, each of the one or more message packets; and
determining, based on a result of the assessment and by the one or more anomaly identifying agents from the plurality of anomaly identifying agents, the intrusion in the one or more message packets.

18. The method of claim 10, wherein the protocol segregator is based on at least one of IEC 61850, DNP3 and Modbus.
